(19) United States
(12) Patent Application Publication
(10) Pub. No.: US 2012/0169855 A1
(43) Pub. Date: Jul. 5, 2012

(54) SYSTEM AND METHOD FOR REAL-SENSE ACQUISITION

(75) Inventor: Hyun-Woo OH, Daejeon (KR)

(73) Assignee: ELECTRONICS AND TELECOMMUNICATIONS RESEARCH INSTITUTE, Daejeon (KR)

(21) Appl. No.: 13/340,273

(22) Filed: Dec. 29, 2011

(30) Foreign Application Priority Data
Dec. 30, 2010 (KR) 10-2010-0138848
Jul. 11, 2011 (KR) 10-2011-0068443
Dec. 26, 2011 (KR) 10-2011-0142430

(51) Int. Cl. H04N 7/18

(52) U.S. Cl. 348/61; 348/E07.085

(57) ABSTRACT

A system for real-sense acquisition, connected to an image obtaining device, includes a sensing means, an environment setting means, a real-sense effect metadata creation means and a start/end processing means. The sensing means creates sensing data by sensing environment around the image obtaining device. The environment setting means sets a reference value for extracting effective data from the sensing data created by the sensing means. The real-sense effect metadata creation means creates real-sense effect metadata by extracting effective data based on the reference value set by the environment setting means from the sensing data created by the sensing means. The start/end processing means controls an operation of the sensing means based on start and end times when the image obtaining device obtains an image.

### CROSS-REFERENCES TO RELATED APPLICATIONS

The present application claims priority of Korean Patent Application Nos. 10-2010-0138848, 10-2011-0068443, and 10-2011-0142430, filed on Dec. 30, 2010, Jul. 11, 2011, and Dec. 26, 2011, respectively, which are incorporated herein by reference in their entirety.

### BACKGROUND OF THE INVENTION

1. Field of the Invention

Exemplary embodiments of the present invention relate to a system and method for real-sense acquisition; and, more particularly, to a system for providing a real-sense effect by sensing ambient environment information through a sensor at a time when a camera photographs an image, extracting an effective data from the sensed information and creating real-sense effect metadata based on the extracted effective data, and a method for real-sense acquisition using the system.

2. Description of Related Art

The term “digital home,” which is frequently mentioned by people, refers to a home that controls a variety of information appliances and digital devices existing in a home and provides high-quality bidirectional multimedia services. The range of digital home, which has been claimed to stand for in the IT839 strategy, was limited to indoor places including a home, an office, etc. However, the range of future digital home will be developed as a ubiquitous home extended to a society, a group, a city, etc. The ubiquitous home can be realized as a home in which digital devices are embedded into a ceiling, a wall, a floor, person's clothes or a body site. Also, the ubiquitous home can be developed into a process of enabling an event occurring at any place to be realized at home by comprehensively applying a real-sense technology based on five senses and an intelligent technology based on self-control cooperation between devices. In the process, it is expected that a ubiquitous home will appear, which enables a person to talk to a dolphin by making the home as a seascape or enables a person to have an illusion as if the person stayed in Guam by making the home as a beach in Guam. The direction of the development of relative technologies and services required in the market should be considered so as to order to implement the ubiquitous home. Media and digital device technologies that are relative technologies will be first described. Media have been variously developed into interactive media, customized media, rich media, five-sense media, immersive media, real-sense experience media, etc. Devices for reproducing the media have also been developed into a digital television (DTV) for supporting high resolution, a digital multimedia broadcasting (DMB) phone for supporting portability, a wall display using a mirror, glass or wall, etc. Generally, the media refer to audio (including voice and sound) and video (including image) signals. Here, the term “contents” is used when the media includes metadata. The current media technology is developed into real-sense media, especially five-sense media that satisfies not only real senses of simply seeing and hearing but also person's five senses. The devices for reproducing the media are also changed from existing devices for reproducing media recorded in an analog format to devices for reproducing media recorded in a digital format, and further developed into a multi-channel audio technology for reproducing a real-sense audio and a high-quality display and stereoscopic image display technology for reproducing a real-sense image. All home electronic devices used in a home are also changed from devices controlled by an analog signal to devices controlled by a digital signal, and further developed so that various devices are controlled by one home server.

The development of media and devices is a result of efforts for conveniently and realistically reproducing media by incorporating a variety of additional information into the media so as to provide more information to a user. This is considered as a development procedure for complying with user's requirement. In actuality, the media and devices are developed under the structure in which the media is developed according to the evolution of the devices or the devices are evolved according to the development of the media. Services based on Single-Media Single-Device (SMSD) are mainly used for the media and devices. In the SMSD (technique for reproducing one media linked with several devices so as to provide an extended media service), media are mapped to devices one by one so as to reproduces a service. In the structure of the services based on the SMSD, stereoscopic sound or stereoscopic image media are developed so that media are more realistically reproduced, and stereoscopic sound or stereoscopic image devices for reproducing the media are developed at the same time. Although it is expected that the media and devices will be substituted for the existing media and devices in the future, technical limitations to be solved still remain until the technologies are completed.

The development of the media and devices requires extension from the concept of media limited to only audio and video in the past to the concept of media linked with various devices. That is the very new media format in which multiple devices can be operated by one media. In fact, the concept of media linked with devices has been already used in various fields.

For example, a music fountain in which the stream of water dances according to music, a vibration joystick or chair for real-sense games, and a Karaoke room illuminating system in which the effect of illumination is changed depending on music are systems for increasing reality or stimulating person's senses because appropriated devices operate according to characteristics of media in the systems. The systems are widely used in our life.

In relation to such a real-sense technology, a paper (‘Architecture of the SMMD Media Service System,’ 6th WSEAS International Conference on E-ACTIVITIES, Tenerife, Spain, Dec. 14-16, 2007) discloses a technique for creating a single next-generation media (ne-media) by adding real-sense effect metadata to one media. Here, the ne-media is a new media format including information on audio, video, text and realistic five senses, digital device control information for expressing the information to a user, and synchronization information. The single ne-media. The single ne-media is created as one file and stored in a home server. The home server is configured into a service structure in which real-sense effect metadata is extracted by reading a ne-media, and a real-sense effect device is controlled in synchronization with the ne-media, thereby maximizing the real-sense effect.

Korean Patent Laid-Open Publication No. 10-2008-0016393 (Ubiquitous Home Media Service Apparatus and Method based on Single-Media Multi-Device, and Home Media Service System and Method using the same, published on Feb. 2, 2008) discloses a technique for creating a media (ne-media) with a new structure, which can add device control and synchronization information for real-sense services to existing media including moving picture, audio and text, inputting real-sense reproduction information suitable for individual's taste and peripheral device environment to the created ne-media and then transmitting the ne-media to peripheral devices, so that devices linked through the ne-media provide a realistic media service to the user regardless of user's physical positions such as a home, an office and a public place.

In the conventional techniques, the ne-media is created by adding a real-sense effect intended by a creator to previously created media, but ambient environment information at a time when a camera photographs an image is not provided in real time. Hence, the real-sense effect at the time when the camera photographs the image is not provided.

Since the conventional techniques use the existing media, the creator should set a reference time for real-sense effect metadata to time information of the existing media. Further, the creator should manually add a real-sense effect to each scene using a creating tool.

Therefore, it is required to develop a system and method for providing a more realistic effect by automatically creating real-sense effect metadata and adding the created metadata to media in precise synchronization with the media at a time when a camera photographs and image, i.e., at an image acquisition time.

### SUMMARY OF THE INVENTION

An embodiment of the present invention is directed to a system and method for providing a real-sense effect by sensing ambient environment information through a sensor at a time when a camera photographs an image, extracting an effective data from the sensed information and creating real-sense effect metadata based on the extracted effective data.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a system for real-sense acquisition, connected to an image obtaining device, includes a sensing means configured to create sensing data by sensing environment around the image obtaining device, an environment setting means configured to set a reference value for extracting effective data from the sensing data created by the sensing means, a real-sense effect metadata creation means configured to create real-sense effect metadata by extracting effective data based on the reference value set by the environment setting means from the sensing data created by the sensing means, and a start/end processing means configured to control an operation of the sensing means based on start and end times when the image obtaining device obtains an image.

In accordance with another embodiment of the present invention, method for real-sense acquisition in a system for real-sense acquisition, connected to an image obtaining device, includes creating sensing data by sensing environment around the image obtaining device, setting a reference value for extracting effective data from the sensing data created by the creating of the sensing data, and creating real-sense effect metadata by extracting effective data based on the reference value set by the setting of the reference value from the sensing data created by the creating of the sensing data. In the method, the creating of the sensing data is controlled based on start and end times when the image obtaining device obtains an image.

### BRIEF DESCRIPTION OF THE DRAWINGS

FIG. 1 is a configuration diagram illustrating an embodiment of a network to which the present invention is applied.

FIG. 2 is a configuration diagram illustrating an embodiment of a system for real-sense acquisition in accordance with the present invention.

FIG. 3 is a flowchart illustrating a method for real-sense acquisition using the system in accordance with the embodiment of the present invention.

FIG. 4 is a block diagram schematically illustrating a structure of the system in accordance with the embodiment of the present invention.

FIG. 5 is a flowchart schematically illustrating an operation of the system in accordance with the embodiment of the present invention.

FIG. 6 is a flowchart schematically illustrating an operation of extracting effective data in the system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In accordance with exemplary embodiments of the present invention, a system for real-sense acquisition automatically creating real-sense effect metadata and enables real-sense broadcasting in real time by sensing information on temperature, humidity and illumination of environment around a camera, movement of the camera, scent, wind, position of the camera through sensors at a time when the camera photographs an image, extracting effective data based on the sensed information, creating real-sense effect metadata including a heat generation effect, a water spray effect, an illumination effect, a motion effect, a scent generation effect, a wind effect and a position effect based on the extracted effective data, and providing the created real-sense effect metadata to a real-sense broadcasting server or SMMD creating server.

In addition, it will be readily understood by those skilled in the art that the system for real-sense acquisition can sense an environment around a camera by applying a sensor for sensing the environment around the camera.

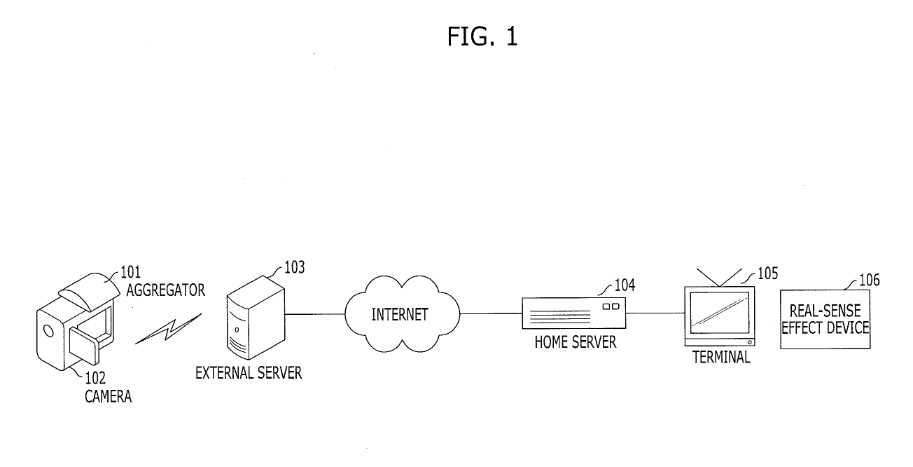

FIG. 1 is a configuration diagram illustrating an embodiment of a network to which the present invention is applied.

As illustrated in FIG. 1, the network in accordance with the embodiment of the present invention includes a system 101 for real-sense acquisition, a camera 102, an external server 103, a home server 104, a terminal 105 and a real-sense effect device 106 for controlling a real-sense effect. The network may be portable Internet (Wi-Fi, Wibro, WiMAX, M-WiMAX, etc.), Long Term Evolution (LTE), etc.

Referring to FIG. 1, the system 101 is used by being attached to the camera 102, and provides a camera image and real-sense effect metadata to the external server such as a real-sense broadcasting server or a real-sense effect creating tool server.

The external server 103 transmits the camera image and real-sense effect metadata to the home server 104 connected to a network through a wired/wireless communication interface.

The home server 104 receiving the camera image and real-sense effect metadata from the external server 103 provides an image to the terminal 105 by parsing media containing the real-sense effect metadata. Simultaneously, the home server 104 analyzes the real-sense effect metadata and maps the analyzed real-sense effect metadata to the real-sense effect device 106. The home server 104 controls the real-sense effect metadata in synchronization with a scene of the image reproduced through the terminal 105.

The terminal 105 reproduces the image provided from the home server 104. The real-sense effect device 106 synchronizes the mapped real-sense effect metadata provided from the home server 104 with the terminal 105, and outputs the synchronized real-sense effect metadata.

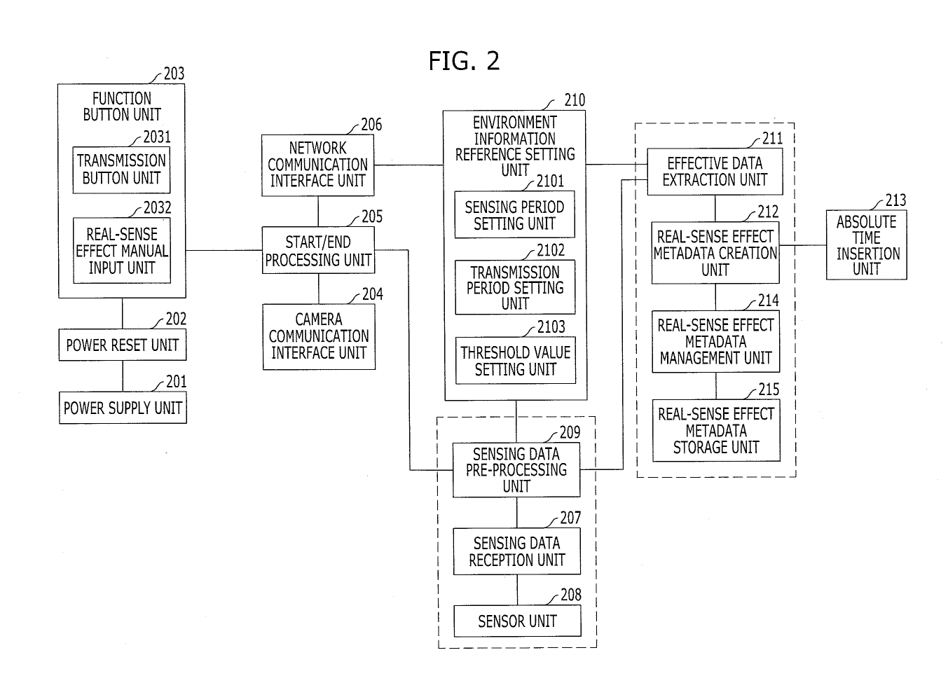

FIG. 2 is a configuration diagram illustrating an embodiment of the system for real-sense acquisition in accordance with the present invention.

As illustrated in FIG. 2, the system for real-sense acquisition includes a power supply unit 201. a power reset unit 202, a function button unit 203, a camera communication interface unit 204, a start/end processing unit 206, a network communication interface unit 206, a sensing data reception unit 207, a sensor unit 208, a sensing data pre-processing unit 209, an environment information reference setting unit 210, an effective data extraction unit 211, a real-sense effect metadata creation unit 212, an absolute time insertion unit 213, a real-sense effect metadata management unit 214 and a real-sense effect metadata storage unit 215.

Referring to FIG. 2, the power supply unit 201 receives power from a camera power source and a portable battery so as to operate the system 101.

When a power button of the system 101 is pressed by a user, the power reset unit 202 applies power to the system 101 so that the system 101 can operate.

The function button unit 203 includes a transmission button unit 2031 and a plurality of real-sense effect manual input unit 2032.

When receiving a power application signal provided through the power reset unit 202 of the system 101, the transmission button unit 2031 initializes information of a plurality of sensors included in the system 101.

The transmission button unit 2031 provides, to the start/end processing unit 205, start-time and end-time messages for creating real-sense effect metadata by sensing information on environment around the camera through the sensors.

If the real-sense effect manual input unit 2032 receives an arbitrary real-sense effect from the user using the system 101 at a time when the camera photographs an image, the real-sense effect manual input unit 2032 creates and provides real-sense effect metadata based on a real-sense effect requested by the user.

For example, if the real-sense effect manual input unit 2032 receives a wind effect from the user at the time when the camera photographs the image, the real-sense effect manual input unit 2032 forcibly creates and provides real-sense effect metadata representing the wind effect.

The camera communication interface unit 204 receives information on a time when the camera starts a photographing operation and information on a time when the camera ends the photographing operation, and provides the information to the start/end processing unit 205.

The start/end processing unit 205 controls an operation of the sensing data reception unit 207 which will be described later. The control of the start/end processing unit 205 is performed based on (i) a message of start and end times at which sensing data for creating real-sense effect metadata is received from the transmission button unit 2031, (ii) recording start and end information of the camera, received from the camera communication interface unit 204, or (iii) a message of start and end times when the sensing data is received through the network communication interface unit 206 from the external server 103.

For example, the network communication interface unit 206 receives a message of start and end times when the external server 103 receives real-sense effect metadata, and provides the received message to the start/end processing unit 206.

The sensing data reception unit 207 receives sensing data obtained by sensing the environment around the camera at the time when the camera photographs an image through the sensor unit 208, and provides the received sensing data to the sensing data pre-processing unit 209. If the sensing data reception unit 207 receives a control message, i.e., the message of the start and end times at the sensing data is received, from the start/end processing unit 205, the sensing data reception unit 207 receives the sensing data sensed by the sensor unit 208 and provides the received sensing data to the sensing data pre-processing unit 209.

The sensor unit 208 manages sensors for sensing environment around the camera from the time when the camera photographs an image. The sensors are a temperature sensor, a humidity sensor, an illumination sensor, an acceleration sensor, an angular speed sensor, a scent sensor, a wind sensor, a Global Positioning System (GPS) sensor, and the like. Accordingly, the environment around the camera is sensed using the sensors. The sensing data pre-processing unit 209 receiving the sensing data from the sensing data reception unit 207 scales the sensing data and removes interference. The sensing data pre-processing unit 209 performs by the 0.1 second, aggregation on data sensed at less than 0.1 second. In this case, the aggregation is generally performed using a mean value.

The sensing data pre-processing unit 209 provides the pre-processed sensing data to the environment information reference setting unit 210. The sensing data pre-processing unit 209 provides, to the effective data extraction unit 211, sensing data collected by a sensing period setting unit 2101 included in the environment information reference setting unit 210.

The environment information reference setting unit 210 sets an environment information reference value based on the sensing data received from the sensing data pre-processing unit 209.

For example, if the environment information reference setting unit 210 receives sending data sensed by the temperature sensor through the sensing data pre-processing unit 209, the environment information reference setting unit 210 sets the sensing data received from the sensing data pre-processing unit 209 to an initial value using a current temperature.

The environment information reference setting unit 210 receives an environment information reference value changed by the external server 103 from the network communication interface unit 206, and sets the reference value for each of the sensors based on the changed environment information reference value.

Here, the environment information reference setting unit 210 includes a sensing period setting unit 2101, transmission period setting unit 2102 and a threshold value setting unit 2103.

The sensing period setting unit 2101 sets a sensing period for sensing the environment around the camera through each of the sensors at the time when the camera photographs the image.

The transmission period setting unit 2102 sets a period for creating real-sense effect metadata based on the sensing data and providing the real-sense effect metadata to the external server or storing the real-sense effect in a memory.

The threshold value setting unit 2103 sets a threshold value for extracting effective data by setting a threshold of variation in the sensing data.

The effective data extraction unit 211 extracts effective data as real-sense effect data from the sensing data received from the sensing data pre-processing unit 209 based on the sensing period, transmission period and threshold value of the environment information reference setting unit 210, and provides the extracted effective data to the real-sense effect metadata creation unit 212.

The real-sense effect metadata creation unit 212 creates real-sense effect metadata based on the effective data received from the effective data extraction unit 211, and provides the created real-sense effect metadata to the real-sense effect metadata management unit 214.

In this case, the real-sense effect metadata creation unit 212 receives a reference time from the absolute time insertion unit 213 so as to set a real-sense effect reproduction time. The real-sense effect metadata includes a real-sense effect time, a start time, a maintenance time, a scaling value, and the like.

The absolute time insertion unit 213 creates a reference time from a time when a start-time message is received from the start/end processing unit 205, and provides the real-sense effect reproduction time to the real-sense effect metadata creation unit 212.

If the real-sense effect metadata management unit 214 receives the real-sense effect metadata from the real-sense effect metadata from the real-sense effect metadata creation unit 212, the real-sense effect metadata management unit 214 identifies whether or not the real-sense effect metadata is in a transmission mode.

When it is identified that the real-sense effect metadata is not in the transmission mode, the real-sense effect metadata is stored in the real-sense effect metadata storage unit 215. When receiving a request for transmission of the real-sense effect metadata stored in the real-sense effect metadata storage unit 215 from the external server 103, the real-sense effect metadata management unit 214 transmits, to the external server 103, the real-sense effect metadata stored in the real-sense effect metadata storage unit 215.

The real-sense effect metadata storage unit 215 receives real-sense effect metadata from the real-sense effect metadata management unit 214, and stores the received real-sense effect metadata in the memory. The real-sense effect metadata storage unit 215 provides the real-sense effect metadata to the real-sense effect metadata management unit 214 in response to the request of the real-sense effect metadata management unit 214.

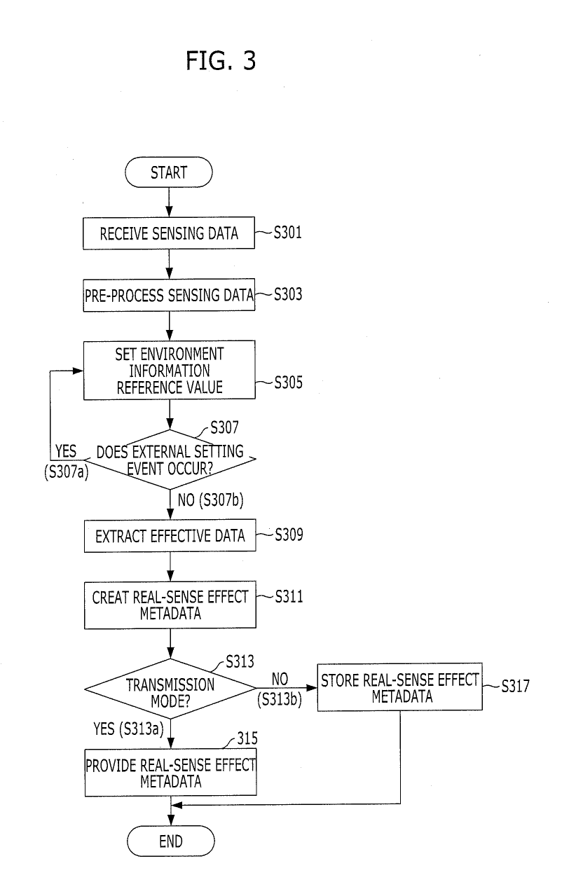

FIG. 3 is a flowchart illustrating a method for real-sense acquisition using the system in accordance with the embodiment of the present invention.

Referring to FIG. 3, at a time when the camera photographs an image, the sensing data reception unit 207 in the system 101 receives sensing data obtained by sensing the environment around the camera through the sensors of the sensor unit 208, and provides the received sensing data to the sensing data pre-processing unit 209 (S301).

The sensing data pre-processing unit 209 receiving the sensing data from the sensing data reception unit 207 pre-processes the sensing data by performing aggregation by the 0.1 second through removal of jitter of the sensing data and scaling of integer and decimal values (S303).

The sensing data pre-processing unit 209 provides the pre-processed sensing data to the environment information reference setting unit 210 and the effective data extraction unit 211.

The environment information reference setting unit 210 receiving the pre-processed sensing data from the sensing data pre-processing unit 209 sets an environment information reference value based on the sensing data (S305).

That is, the environment information reference setting unit 210 identifies the sensing data pre-processed by being sensed by the temperature sensor. For example, it is assumed that a current temperature is 20° C. If a temperature is changed by 5° C. using the current temperature of 20° C. as a reference value, the environment information reference setting unit 10 sets the current temperature as the reference value so as to operate a heating device.

The environment information reference setting unit 210 identifies whether or not an external setting event occurs from the external server 103 (S307).

As the identified result (S307), when the external setting event occurs from the external server 103 (S307a), the environment information reference setting unit 210 returns to the step S305 and resets the environment information reference value based on the external setting event that has occurred from the external server 103.

That is, if the external server 103 is connected to the system 101, the environment information reference setting unit 210 changes a setting mode into an external setting mode, and resets the sensing period, transmission period and threshold value, which are environment information reference values, for each of the sensors.

In the environment information reference setting unit 210, the sensing period, transmission period and threshold value are changed by the external server 103.

As the identified result (S307), when the external setting event does not occur from the external server 103 (S307b), the effective data extraction unit 211 receiving the sensing data from the sensing data pre-processing unit 209 extracts effective data through the sensing period, transmission period and threshold value, sensed by the environment information reference setting unit 210, and provides the extracted effective data to the real-sense effect metadata creation unit 212 (S309).

The real-sense effect metadata creation unit 212 creates real-sense effect metadata based on the effective data received from the effective data extraction unit 211, and provides the created real-sense effect metadata to the real-sense effect metadata management unit 214 (S311).

If the real-sense effect metadata management unit 214 receives the real-sense effect metadata from the real-sense effect metadata creation unit 212, the real-sense effect metadata management unit 214 identifies whether or not the real-sense metadata is in a transmission mode (S313).

As the identified result (S313), when the real-sense effect metadata is in the transmission mode (S313a), the real-sense effect metadata management unit 214 transmits the real-sense effect metadata to the external server 103 connected to the outside through the network communication interface unit 206 (S315).

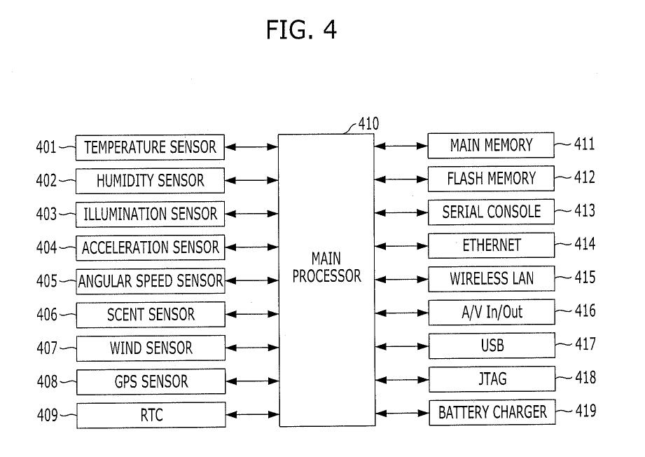

As the identified result (S313), when the real-sense effect metadata is not in the transmission mode (S313b), the real-sense effect metadata management unit 214 stores the real-sense effect metadata in the real-sense effect metadata storage unit 215 (S317). Hereinafter, the system for generating real-sense effect metadata such as a heat generation effect, an illumination effect, a water spray effect, a motion effect, a scent generation effect, a wind effect and a position effect, based on sensors such as temperature, illumination, humidity, acceleration, angular speed, scent, wind and GPS sensors will be described in detail with reference to FIG. 4.

FIG. 4 is a block diagram schematically illustrating a structure of the system in accordance with the embodiment of the present invention.

Referring to FIG. 4, the system includes a main processor 410 for real-sense acquisition, a main memory 411 and a battery charger 419 used in a mobile environment. The system includes sensors such as a temperature sensor 401, a humidity sensor 402, an illumination sensor 403, an acceleration sensor 404, an angular speed sensor 405, a scent sensor 406, a wind sensor 407 and a GPS sensor 408, and an RTC 409 for providing time information to real-sense effect metadata. In addition, the system includes a flash memory 412 for storing real-sense effect metadata generated based on sensing data respectively sensed by the sensors and downloading the real-sense effect metadata to an external server on off-line.

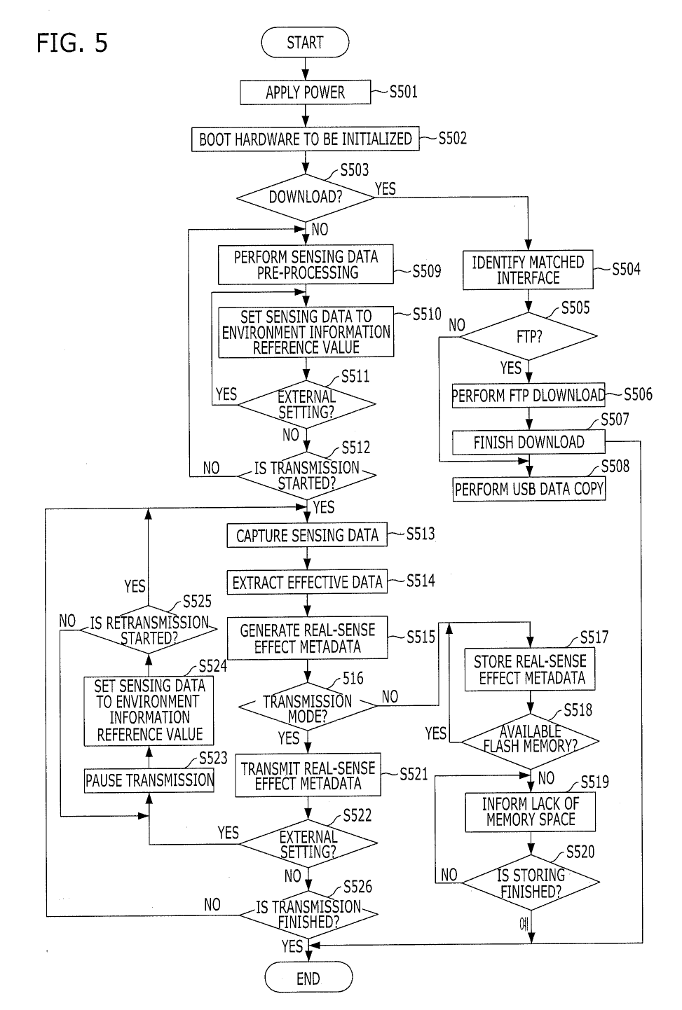

The system identifies a booting process through a serial console 413, and controls a sensing period of each of the sensors by executing a command in the serial console 413. The system includes an audio/video (A/V) input/output interface 416 for transmitting and downloading the generated real-sense effect metadata to the external server through a built-in Ethernet 414 or wireless LAN 415 and bypassing camera images to the external server using the Ethernet 414 or wireless LAN 415. The system includes a USB interface 417 for receiving an event on pressing a recording button of a camera, and the USB interface 417 is used as an interface for downloading the real-sense effect metadata stored in the flash memory 412 to the external server. In addition, the system includes a JTAG interface 418 for upgrading firmware. Hereinafter, an operation of sensing a real-sense effect and generating real-sense effect metadata using the system in accordance with the embodiment of the present invention will be described in detail with reference to FIG. 5.

FIG. 5 is a flowchart schematically illustrating an operation of the system in accordance with the embodiment of the present invention.

Referring to FIG. 5, if power is applied to the system (S501), the system is booted to initialize hardware (S502). If an aggregator, i.e., the system is connected to an external server such as a creation tool server through a USB interface or wired/wireless interface in the booting process, the system checks whether or not to download real-sense effect XML data stored in the built-in flash memory (S503). If a user decides to download, the system identifies a matched interface (S504).

Then, the system checks whether or not to perform FTP download based on the currently connected interface (S505). If the system is connected to the external server through the wired/wireless interface, the system performs the FTP download (S506). If the FTP download is completed, the system finishes the downloading process (S507). If the system does not perform the FTP download, the system performs USB data copy through the USB interface (S508). The USB data copy is completed, the system finishes the downloading process (S507).

Meanwhile, if the user does not select the downloading of the real-sense effect XML data (S503), the system performs a process of pre-processing sensing data sensed by a hardware-initialized sensor (S509). In the process of pre-processing the sensing data, the system removes the jitter of the sensing data and performs scaling of integer and decimal values and aggregation by the 0.1 second.

The system sets the sensing data subjected to the pre-processing process as an environment information reference value (S510). For example, it is assumed that a current temperature is 20° C. If a temperature is changed by 5° C. using the current temperature of 20° C. as a reference value, a heating device is turned on to a first step. Here, the reference value is set to a value obtained in a process of recovering the equability of the sensing data.

When the process of pre-processing the sensing data and the process of setting the environment information reference value are repeated, an external setting event may occur from the external server (S511). For example, if the system is connected to the external server based on Web or through Telnet, the system changes a setting mode into an external setting mode (S511), and sets a transmission period, a sensing period and a threshold value, which are environment information reference values, for each of the sensors (S510). That is, the sensing period, transmission period and the threshold value are changed through the connection to the system from the external server.

In this case, if the user presses a recording button of the camera or presses a transmission start button or if the system receives a transmission start message from the external server (S512), the reception unit 207 of the system performs sensing data capture from the sensors (S513), and the effective data extraction unit 211 performs effective data extraction on the received sensing data in consideration of the sensing period, the transmission period and the threshold value (S514). The real-sense effect metadata generation unit 212 generates real-sense effect XML metadata from the effective data extracted by the effective data extraction unit 211 (S515).

If the generated real-sense effect XML metadata is in a transmission mode, the system transmits the real-sense effect XML metadata, i.e., real-sense effect metadata (S521). If the generated real-sense effect XML metadata is not in a transmission mode, the system stores the real-sense effect metadata in the flash memory (S517). If an available flash memory for storing the real-sense effect metadata does not exist, the system informs the user of the lack of a memory space (S519), and finishes the storing of the real-sense effect metadata (S520).

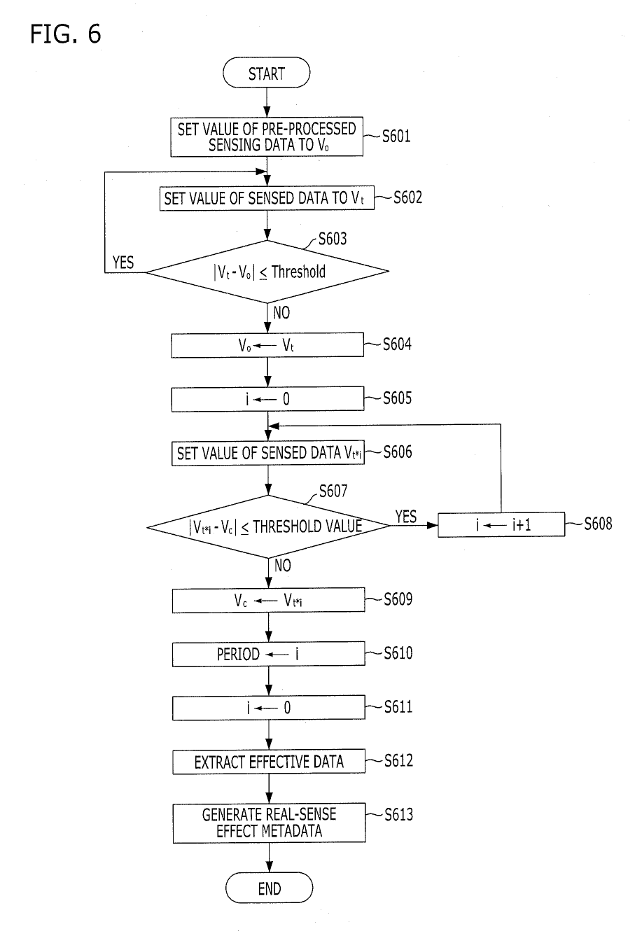

When an external setting from the external server exists while the real-sense effect metadata is transmitted (S522), i.e., when the environment information reference is changed as described above, the system pauses the transmission of the real-sense effect metadata (S523), and resets the environment information reference value. Then, the system identifies that the transmission of the real-sense effect metadata has be restarted, and performs the sensing data capture based on the changed environment information reference value (S513). If the transmission of the real-sense effect metadata is finished by pressing the transmission button unit 2031 (S526), the transmission of the real-sense effect metadata is finished, and thus the operation of the system is finished. Hereinafter, an operation of extracting effective data in the system in accordance with the embodiment of the present invention will be described in detail with reference to FIG. 6.

FIG. 6 is a flowchart schematically illustrating an operation of extracting effective data in the system in accordance with the embodiment of the present invention.

Referring to FIG. 6, before the start/end processing unit 205 provides a start event, the system sets the value of sensing data pre-processed in the environment information reference setting unit 210 to value V₀ (S601). Then, the system sets the value of data sensed at time t to value Vₜ (S602).

The system compares a predetermined threshold value with a value obtained by subtracting the initial value V₀ from the value Vₜ of the data sensed at the time t and taking an absolute value of the subtracted value (S603). If the value obtained by taking the absolute value of the subtracted value does not exceed the threshold value, the system sets the value of the sensing data to the value Vₜ at the next time t. If the value obtained by taking the absolute value of the subtracted value exceeds the threshold value, the system sets the value Vₜ to current reference value V_{c} (S604).

Then, the system initializes index i (S605) and then sets the value of data sensed at time t+i to value Vₜ₊ᵢ (S606). The system compares the threshold value with a value obtained by subtracting the current reference value V_{c} from the value Vₜ₊ᵢ and taking an absolute value of the subtracted value (S607). If the value obtained by taking the absolute value of the subtracted value does not exceed the threshold value, the system increases the index i (S608) and sets the value of the data sensed at time t+i to value Vₜ₊₁ (S606). If the value obtained by taking the absolute value of the subtracted value exceeds the threshold value, the system sets the value Vₜ₊ᵢ to the current reference value V_{c} (S609), sets the index i to the value of a period in which the real-sense effect is continued (S610), and initializes the index i (S611). The system extracts the value V_{c} obtained through the processes described above as effective data (S612), and generates real-sense effect metadata by adding the period in which the real-sense effect is continued to the real-sense effect metadata (S613). The processes are repeatedly performed.

In accordance with the exemplary embodiments of the present invention, effective data is extracted by sensing information on environment around a camera at a time when the camera obtains an image, and real-sense effect metadata is generated and provided using the extracted effective data, so that it is possible to provide more realistic sense and realism. The real-sense effect metadata transmitted to a real-sense broadcasting server connected to the outside, so that it is possible to reproduce an image and real-sense effect in real time.

Further, effective data is extracted based on sensing data, and real-sense effect metadata is created using the effective data and stored in a memory, so that it is possible to edit a real-sense effect using a creating tool and create and output media including the real-sense effect by providing the real-sense effect metadata to an external server such as a creation tool server.

Furthermore, a user photographing an image using a camera can add real-sense effect metadata at an arbitrary time. The user can control the generation of real-time effect metadata for each sensor by freely changing an environment information reference value of the system for real-sense acquisition.

While the present invention has been described with respect to the specific embodiments, it will be apparent to those skilled in the art that various changes and modifications may be made without departing from the spirit and scope of the invention as defined in the following claims.

What is claimed is:

1. A system for real-sense acquisition, connected to an image obtaining device, the system comprising:
a sensing means configured to create sensing data by sensing environment around the image obtaining device;
an environment setting means configured to set a reference value for extracting effective data from the sensing data created by the sensing means;
a real-sense effect metadata creation means configured to create real-sense effect metadata by extracting effective data based on the reference value set by the environment setting means from the sensing data created by the sensing means; and
a start/end processing means configured to control an operation of the sensing means based on start and end times when the image obtaining device obtains an image.

2. The system of claim 1, wherein the environment setting means comprises:
a sensing period setting unit configured to set a sensing period of the sensing means; and
a threshold value setting unit configured to set a threshold value for extracting effective data from the sensing data created by the sensing means.

3. The system of claim 1, wherein the real-sense effect metadata creation means comprises:
an effective data extraction unit configured to extract effective data based on the reference value set by the environment setting means from the sensing data created by the sensing means; and
a real-sense effect metadata creation unit configured to create real-sense effect metadata based on the extracted effective data.

4. The system of claim 1, wherein the start/end processing means controls the operation of the sensing means based on an external input except the start and end times when the image obtaining device obtains the image.

5. The system of claim 1, wherein the sensing means comprises at least one of a temperature sensor, a humidity sensor, an illumination sensor, an acceleration sensor, an angular speed sensor, a scent sensor, a wind sensor and a GPS sensor.

6. The system of claim 1, wherein the real-sense effect metadata comprises at least one of a real-sense effect type, a start time, a maintenance time and a scaling value (percentage).

7. A method for real-sense acquisition in a system for real-sense acquisition, connected to an image obtaining device, the method comprising:
creating sensing data by sensing environment around the image obtaining device;
setting a reference value for extracting effective data from the sensing data created by said creating of the sensing data; and
creating real-sense effect metadata by extracting effective data based on the reference value set by said setting of the reference value from the sensing data created by said creating of the sensing data,
wherein said creating of the sensing data is controlled based on start and end times when the image obtaining device obtains an image.

8. The method of claim 7, wherein said creating of the real-sense effect metadata comprises:
extracting effective data based on the reference value set by said setting of the reference value from the sensing data created by said creating of the sensing data; and
creating real-sense effect metadata based on the extracted effective data.

9. The method of claim 7, wherein said creating of the sensing data is controlled based on an external input except the start and end times when the image obtaining device obtains the image.

10. The method of claim 7, wherein the real-sense effect metadata comprises at least one of a real-sense effect type, a start time, a maintenance time and a scaling value (percentage).
